(19) United States
(12) Patent Application Publication
(10) Pub. No.: US 2011/0068710 A1
(43) Pub. Date: Mar. 24, 2011

(54) ADJUSTING DEVICE FOR REGULATING THE ILLUMINATION OF A LAMP AND THE METHOD THEREOF

(76) Inventors: Guang-Yi WU, Zhejiang (CN); Shao-Ai Xiang, Zhejiang (CN)

(21) Appl. No.: 12/619,470

(22) Filed: Nov. 16, 2009

(30) Foreign Application Priority Data
Jan. 10, 2009 (CN) 200910095614.1

(51) Int. Cl. H05B 37/02

(52) U.S. Cl. 315/307

(57) ABSTRACT

The present invention comprises a rectifier-filter circuit, an active power factor correction (PFC), an oscillating circuit, a boost circuit, a tube circuit, an internal power, a sampling circuit, a micro controller unit (MCU), a detecting circuit, and a power switch to regulate the brightness of a lamp. Wherein, a parameter set in the MCU would accordingly help the MCU trigger the consecutive oscillating switching time and frequency. The sampling circuit acquires the data of the consecutive switching time and frequency and sends the MCU the data to determine whether to correspondingly send a control signal for starting the oscillating circuit and starting the frequency, pulse width, number of channels of the oscillating circuit. Therefore, the present invention is accomplished through the control signal of the MCU passing through the oscillating circuit and the tube circuit, conducing to a convenient adjustment, an energy saving competence, and the long-lived lamp and switch.

### BACKGROUND OF THE INVENTION

1. Field of the Invention

The present invention relates to an illuminating device, in particularly to an adjusting device for regulating the illumination of a lamp and method thereof.

2. Description of the Related Art

The brightness regulation of a lamplight is so-called light tuning, which means to alter the illuminated device and to vary the process of light outputting. Generally, a light tuning can be directed to a continuous light tuning or a stepping light tuning. Further, if an illuminated device is adjustable, a preferable energy saving efficiency can be achieved and human's sense of sight is readily adapted to an environment. Thus, an adjusting device for tuning light is extensively applied. The following adjusting devices for tuning light and the methods thereof are the current applications:
1. A method of phase controlled tuning utilizes a silicon controlled conduction angle. In this method, the light tuning is achieved by altering a switching thyristor conduction angle. As a result, the controlled silicone in a current can accomplish a contactless control in an alternating current, so that a smaller current can control a large current, which advantages the product a faster movement and a reliable merit. However, the manufacturing cost of this kind of product is high and it is accordingly complicated to control such product. Moreover, the current has a smaller capacity but larger power consumption, resulting in a serious heating temperature thereof. Therefore, this kind of tuning method is inappropriate to be extensively applied.
2. A method of light tuning through an additive control wire in the current is advantageous to a lower manufacturing cost, but the original circuit thereof has to be changed, which is more inconvenient.
3. A method of light tuning utilizes a switch loop being controlled. In this method, the light is turned on first while operation, and then the light can be tuned by the circulating times of a switch loop. Obviously, this method is advantageous of a simple operation, but is however disadvantageous of a short life of the switch after a plurality of circulations being applied. Moreover, the switch always suffers a larger current impact when the switch current passes therethrough.

### SUMMARY OF THE INVENTION

The object of the present invention is to provide an adjusting device for regulating the illumination of a lamp advantageous of a convenient tuning, energy saving, and long using life.

An adjusting device in accordance with the present invention essentially comprises a rectifier-filter circuit, an active power factor correction (PFC), an oscillating circuit, a boost circuit, a tube circuit, an internal power, a sampling circuit, a micro controller unit, a detecting circuit, and a power switch.

Wherein, the rectifier-filter circuit connects to the power switch for transmitting an alter signal to a direct signal and for filtering clutter of the power to more stabilize the power and prevent the clutter inside the rectifier from a outwardly radiation, so that the rectifier would meet the EMC standard.

The active power factor correction (PFC) connects to the rectifier-filter circuit for promoting a power factor of the rectifier, so that the power factor of the rectifier can be promoted from 0.5 to 0.98, which preferably decreases a voltage and a harmonic current under 10% thereof to lessen the pollution to an electrified wire fence.

The oscillating circuit connecting to the active power factor correction (PFC) provides the lamp with an essential oscillating signal and power driving so as to alter the power and the brightness of a single lamp through regulating the oscillating frequency, the pulse width, and the number of channel according to a controlling demand from the micro controller unit (MCU) while the light tuning is directed to one single lamp. Alternatively, while the light tuning is directed to multiple lamps, a plurality of oscillating circuits and boost circuits as well as tube circuits are accordingly added conforming to the control demand from the micro controller unit (MCU), so that the brightness regulation of the multiple lamps would depend on the number of lighted channels in the lamps being controlled by the switch.

The boost circuit connects to the oscillating circuit being output conforming to the power of the oscillating circuit so as to satisfy a soaring voltage while the lamp is turned on or a descending voltage while the lamp is turned off.

The tube circuit connects to the boost circuit, so that the lamp can be turned on or turned off.

The sampling circuit connects to the rectifier-filter circuit to acquire a corresponding frequency and voltage according to the switching time and switching frequency of the power switch for the micro controller unit (MCU) to sense.

The micro controller unit (MCU) connects to the sampling circuit to receive the data information of the switching time and frequency from the sampling circuit. By a further cooperation with an internal program, the micro controller circuit would decide the switch condition, such as turning-on, turning-off, or oscillation tuning, to adjust the oscillation thereof. Moreover, the micro controller circuit also connects to the oscillating circuit so as to control an oscillating frequency, a pulse width, and a number of channels of the oscillating circuit. That is, the adjustment of illumination of the present invention is achieved by the regulations of the frequency, the pulse width, and the number of channels. In addition, the micro controller unit also connects to the detecting circuit to receive a signal showing the working condition from the detecting circuit to the lamp so as to control the oscillating circuit having a conforming adjustment.

The detecting circuit connects to the oscillating circuit and the boost circuit to determine if the circuits and the lamp function normally according to the sampling signal. The detecting circuit further connects to the micro controller unit for feeding a detecting signal to the program installed in the micro controller unit to process.

An internal power connects to the active power factor correction (PFC), the oscillating circuit, and the micro controller unit, respectively, to provide the modules above with electricity.

The power switch provides the entire system of the present invention with electricity.

The other object of the present invention is to provide a method for regulating the illumination of a lamp including steps of:
1. Setting a parameter to start a consecutive switching time as well as a consecutive switching frequency for oscillating in a micro controller unit;
2. A sampling circuit acquiring a piece of data information of the consecutive switching time as well as frequency for sending the data information to the micro controller unit;
3. The micro controller unit sending a control signal for deciding whether to start the oscillating circuit as well as start a control signal of frequency, a pulse width, and a number of channels of the oscillating circuit according to the data information of the consecutive switching time as well as frequency from the sampling circuit; and
4. The adjustment of the illumination of the lamp is achieved via the oscillating circuit and a tube circuit according to the control signal sending from the micro controller unit.

Alternatively, while the tube circuit is operated, a detecting circuit would acquire a working data from the oscillating circuit and a boost circuit to feed the working data to the micro controller unit, so that the micro controller unit would determine whether the circuits and the tube function normally according to the data for correspondingly adjusting the oscillating frequency, the pulse width, and the number of channels.

As a result, the present invention has the following benefits:
1. The outputting power of the lamp or the number of the lighted lamp is controlled through the consecutive switching frequencies of the power switch, so the present invention needs not be controlled by the disconnection through a switch loop as provided by the conventional product, but the present invention can still achieve the purpose of a fast illuminant adjustment.
2. During the consecutive switching, the lamp is not lighted yet, which conduces to a longer using life of the lamp, so that the switch would not be attacked by a large power current; that is, the switch current of the present invention is 1/20 as smaller as that of the conventional product, which also accordingly promotes the using life of the switch.
3. The existing illuminant circuits and switch do not have to be altered if the present invention is applied. Only a new lamp or a rectifier is needed to be changed to accomplish the function of light adjusting. Therefore, the cost of the present invention is low, which is more appropriate to be applied in industry and extensively popularized.

### BRIEF DESCRIPTION OF THE DRAWINGS

FIG. 1 is a block diagram showing the present invention;

FIG. 2 is a schematic view showing the circuit structure of the present invention; and

FIG. 3 is a block diagram showing the fundamental principle of the present invention.

### DETAILED DESCRIPTION OF THE PREFERRED EMBODIMENTS

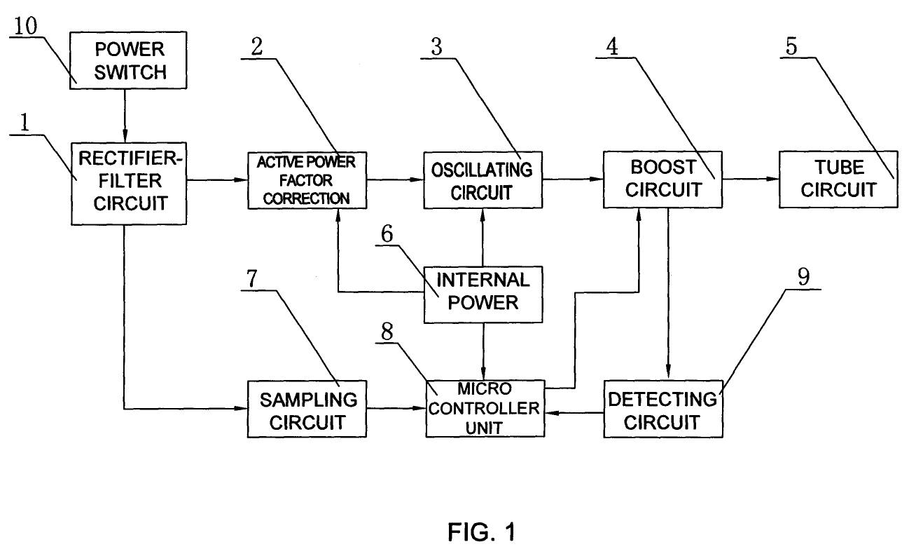

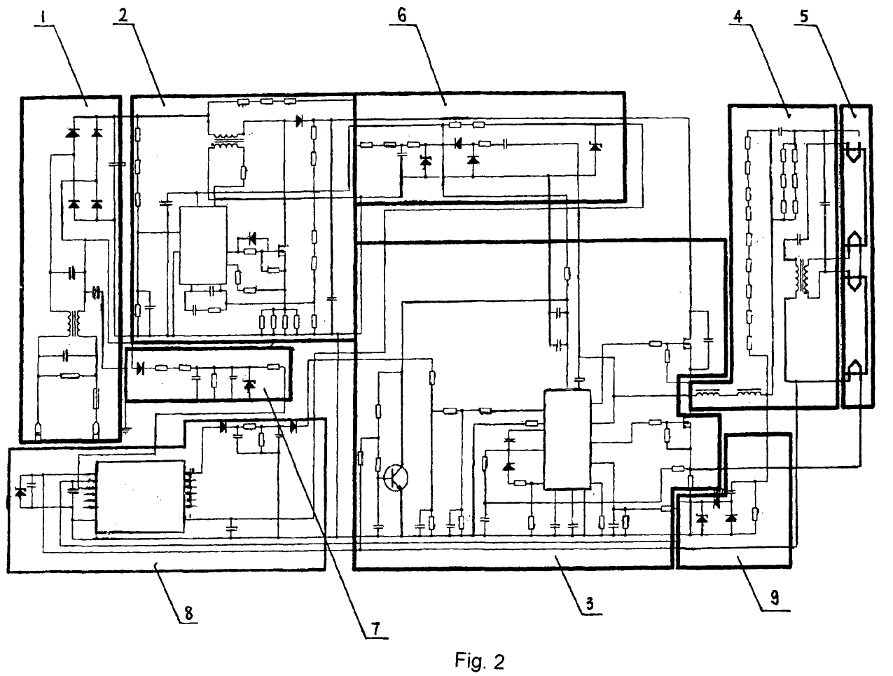

Referring to FIGS. 1 and 2 showing the present invention pertaining to an adjusting device for regulating the illumination of a lamp comprising a rectifier-filter circuit 1, an active power factor correction (PFC) 2, an oscillating circuit 3, a boost circuit 4, a tube circuit 5, an internal power 6, a sampling circuit 7, a micro controller unit 8, a detecting circuit 9, and a power switch 10.

Wherein, the rectifier-filter circuit 1 connects to the power switch 10 for transmitting an alter signal to a direct signal and for filtering a clutter of the power to more stabilize the power and prevent the clutter inside the rectifier from a outwardly radiation, so that the rectifier would meet the EMC standard.

The active power factor correction (PFC) 2 connects to the rectifier-filter circuit 1 for promoting a power factor of the rectifier, so that the power factor of the rectifier can be promoted from 0.5 to 0.98, which preferably decreases a voltage and a harmonic current under 10% thereof to lessen the pollution to an electrified wire fence.

The oscillating circuit 3 connecting to the active power factor correction (PFC) 2 provides the lamp with an essential oscillating signal and power driving so as to alter the power and the brightness of a single lamp through regulating the oscillating frequency, the pulse width, and the number of channels according to a controlling demand from the micro controller unit (MCU) while the light tuning is directed to one single lamp. Alternatively, while the light tuning is directed to multiple lamps, a plurality of oscillating circuits and boost circuits as well as tube circuits are accordingly added conforming to the control demand from the micro controller unit (MCU), so that the brightness regulation of the multiple lamps depends on the number of lighted channels in the lamps being controlled by the switch.

The boost circuit 4 connects to the oscillating circuit 3 being output conforming to the power of the oscillating circuit 3 so as to satisfy a soaring voltage while the lamp is turned on or a descending voltage while the lamp is turned off.

The tube circuit 5 connects to the boost circuit 4, so that the lamp can be turned on or turned off.

The sampling circuit 7 connects to the rectifier-filter circuit 1 to acquire a corresponding frequency and voltage according to the switching time and switching frequency of the power switch 10 for the micro controller unit (MCU) 8 to sense.

The micro controller unit (MCU) 8 connects to the sampling circuit 7 to receive the data information of the switching time and frequency from the sampling circuit. By a further cooperation with an internal program, the micro controller circuit would decide the switch condition, such as turning-on or turning-off, to adjust the oscillation thereof. Moreover, the micro controller circuit also connects to the oscillating circuit 3 so as to control an oscillating frequency, a pulse width, and a number of channels of the oscillating circuit 3. That is, the adjustment of illumination of the present invention is achieved by the regulations of the frequency, the pulse width, and the number of channels. In addition, the micro controller unit 8 also connects to the detecting circuit 9 to receive a signal showing the working condition from the detecting circuit to the lamp so as to control the oscillating circuit 3 having a conforming adjustment.

The detecting circuit 9 connects to the oscillating circuit 3 and the boost circuit 4 to determine if the circuits and the lamp function normally according to the sampling signal. The detecting circuit further connects to the micro controller unit 8 for feeding a detecting signal to the program installed in the micro controller unit 8 to process.

An internal power 6 connects to the active power factor correction (PFC) 2, the oscillating circuit 3, and the micro controller unit 8, respectively, to provide the modules above with electricity.

The power switch 10 provides the entire system of the present invention with electricity.

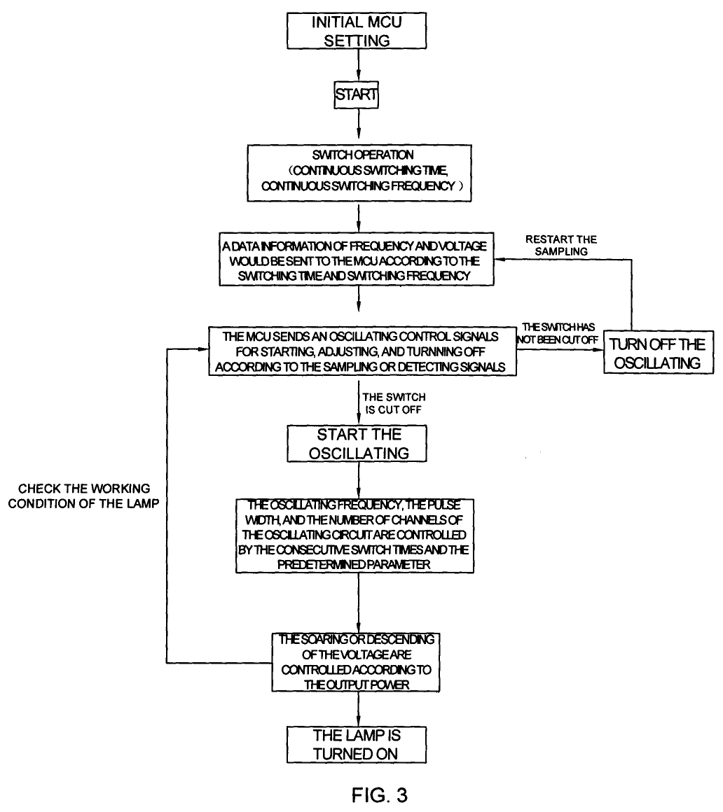

Further referring to FIG. 3, the working principle of the present invention is shown as follows:

The product of the present invention would be set with an MCU parameter to meet client's demand before selling. For example, the consecutive switching time is set as many as one second, and the consecutive switching frequency is set as many as three times. After the initial setting of the MCU is finished, the product can be applied. Whereby, when the switch is firstly turned on, a voltage signal is provided, and little current passes through the switch; concurrently, the oscillating circuit is not started. Further, the sampling circuit sends the parameter of the frequency and voltage of the switching time and frequency to the MCU, so that the MCU would start the oscillating circuit according to the time interval. Herein, if the time interval is below one second, the MCU would not trigger the oscillating circuit to oscillate and wait till the interval is longer than one second. When the time interval is longer than one minute, the MCU would trigger the oscillating circuit to oscillate the frequency, the pulse width (applied to a single lamp), or the number of channels (applied to multiple lamps) via a control voltage signal according to the counted switching frequency. Therefore, the oscillating circuit would provide an essential oscillating signal and power driven to the lamp according to the control voltage signal from the MCU so as to light the lamp through the boost circuit. Alternatively, while the tube circuit is operated, the detecting circuit would acquire a working data from the oscillating circuit and the boost circuit to feed the working data to the micro controller unit, so that the micro controller unit would determine whether the circuits and the tube function normally for correspondingly adjusting the oscillating frequency, the pulse width, and the number of channels.

To sum up, the present invention takes advantage of the MCU controlling the oscillating circuit and frequency as well as pulse width to regulate the brightness of a single lamp. When multiple lamps are to be regulated, a plurality of oscillating circuits and boost circuits are accordingly added for the MCU to control the number of channels of the oscillating circuit to accomplish the regulation of brightness thereof. Therefore, this kind of adjustment is convenient and the lamp does not have to be lighted while a consecutive switching is executed, resulting in an energy saving efficiency and a promotion of the using life of the lamp.

I claim:

1. An adjusting device for regulating a lamp's illumination comprising a rectifier-filter circuit (1), an oscillating circuit (3), a boost circuit (4), a tube circuit (5), and a power switch (10); wherein, said adjusting device further including:
a sampling circuit (7) connecting to said rectifier-filter circuit (1) so as to acquire a piece of data information of a consecutive switching time and a consecutive switching frequency from said power switch (10) and send said data information to a micro controller unit (8); and
a micro controller unit (8) connecting to said sampling circuit (7) and said oscillating circuit (3) so as to receive said data information of said consecutive switching time and frequency from said sampling circuit (7) for accordingly sending a control signal to said oscillating circuit (3) to decide whether to start said oscillating circuit (3) as well as whether to start a frequency, a pulse width, and a number of channels of said oscillating circuit (3), whereby achieving an adjustment of illumination.

2. The adjusting device as claimed in claim 1, wherein, said rectifier-filter circuit (1) connects to said power switch (10) for transmitting an alter signal to a direct signal and for filtering clutter of said power to more stabilize said power and prevent said clutter inside said rectifier from a outwardly radiation.

3. The adjusting device as claimed in claim 1, wherein, said adjusting device further includes an active power factor correction (2) connecting to said rectifier-filter circuit (1) for promoting a power factor of said rectifier.

4. The adjusting device as claimed in claim 1, wherein, said oscillating circuit (3) provides said lamp with an essential oscillating signal and power driving so as to alter said oscillating frequency, said pulse width, and said number of channel thereof according to a controlling demand from said micro controller unit (8), whereby achieving an adjustment of illumination.

5. The adjusting device as claimed in claim 1 or 4, wherein, said oscillating circuit (3), said boost circuit (4), and said tube circuit (5) consist a set so as to be altered with its oscillating frequency and pulse width to achieve an adjustment of illumination.

6. The adjusting device as claimed in claim 1 or 4, wherein, said oscillating circuit (3), said boost circuit (4), and said tube circuit (5) consist a plurality of sets to be altered with their number of channels to achieve an adjustment of illumination.

7. The adjusting device as claimed in claim 1, wherein, said adjusting device further includes a detecting circuit (9) connecting to said oscillating circuit (3) and said boost circuit (4) to acquire a sampling signal to determine whether said circuits and said lamp function normally; moreover, said detecting circuit (9) further connects to said micro controller unit (8) for feeding a detected signal to said micro controller unit to process.

8. The adjusting device as claimed in claim 1, wherein, said adjusting device further includes an internal power (6) connecting to said active power factor correction (2), said oscillating circuit (3), and said micro controller unit (8), respectively, for providing electricity.

9. A method to adjust an illumination of a lamp comprising steps of:
Firstly, setting a parameter in a micro controller unit (8) to start a consecutive switching time as well as a consecutive switching frequency for oscillating;
Secondly, a sampling circuit (7) acquiring a piece of data information of said consecutive switching time as well as frequency for sending said data information to said micro controller unit (8);
Thirdly, said micro controller unit (8) sending a control signal for deciding whether to start said oscillating circuit (3) as well as start a control signal of frequency, a pulse width, and a number of channels of said oscillating circuit (3) according to said data information of said consecutive switching time as well as frequency; and
Fourthly, said adjustment of said illumination of said lamp being achieved via said oscillating circuit (3) and a tube circuit (5) according to said control signal sending from said micro controller unit (8).

10. The method as claimed in claim 9, wherein, while said tube circuit (5) is operated, a detecting circuit (9) would acquire a working data from said oscillating circuit (3) and a boost circuit (4) to feed said working data to said micro controller unit (8), so that said micro controller unit (8) would determine whether said circuits and said tube function normally according to said data for correspondingly adjusting said oscillating frequency, said pulse width, and said number of channels.
